(19) United States
(12) Patent Application Publication
(10) Pub. No.: US 2013/0050595 A1
(43) Pub. Date: Feb. 28, 2013

(54) Liquid Crystal Lens and 3D Display Device

(71) Applicant: Chihtsung Kang, Shenzhen (CN)

(72) Inventor: Chihtsung Kang, Shenzhen (CN)

(21) Appl. No.: 13/375,478

(22) PCT Filed: Sep. 9, 2011
(86) PCT No.: PCT/CN2011/079543

§ 371 Date: Nov. 30, 2011

(30) Foreign Application Priority Data
Aug. 26, 2011 (CN) 201110249293.3

(51) Int. Cl. G02F 1/1335; G02F 1/13

(52) U.S. Cl. 349/15; 349/200

(57) ABSTRACT

The present invention discloses a liquid crystal lens and a 3D display device thereof, said liquid crystal lens comprises a lower layer basal plate provided with an electrode and an upper layer basal plate provided with a counter electrode, the lower layer basal plate and the upper layer basal plate are mutually and oppositely arranged, and said electrode and the counter electrode are mutually insulated to form an electric field; and a liquid crystal layer arranged between said lower layer basal plate and the upper layer basal plate; the liquid crystals are vertical negative nematic LCs; the electrode of said lower layer basal plate or the counter electrode of said upper layer basal plate is provided with concave curved structures which make the distance between the electrode and the counter electrode smaller. Because the liquid crystal lens is provided with concave curved structures which can make the distance between the electrode and the counter electrode smaller, the field intensity in the electric field has gradience variation and the tilting angle of the liquid crystal molecules in the liquid crystal layer is also in gradience variation under the action of the electric field; therefore, the liquid crystal layer produces the refractive index in gradience variation; and the liquid crystal lens of which the refractive index is in gradience variation is formed and applied to the LCD to achieve the 3D display effect.

### TECHNICAL

The present invention relates to the field of lenses and glassless 3D displays, particularly to a liquid crystal lens and a 3D display device thereof.

### BACKGROUND

The existing lens is an ordinary optical lens and its focal distance is usually constant, limiting the use of lens in many fields. Take the field of glassless 3D displays as an example. The glassless 3D technique requires that the image signals of left and right eyes on the panel are refracted to the corresponding watching positions of left and right eyes. The familiar glassless 3D technique is that the light paths are designed for index matching by using the lenticular lens. As shown in FIG. 1, the principle of the lenticular lens is that a layer of lenticular lens 12 is added in front of the display screen 11, so that the image plane of the display screen 11 is positioned in the focal plane of the lens; and the pixel of the image under each lenticular lens 2 is divided into several subpixels. Thus, the lens can project each subpixel in different directions, so that both eyes of a watcher can watch the display screen at differnt angles, can see different subpixels, and then can see the 3D image.

In addition to the design of the lenticular lens, there is a common design of the grin lens which uses the gradience variation of refractive index. As shown in FIG. 2, as the ordinary bitoric lens, the light forms the focus with the same focal distance in the front part and the rear part through the density structure of the grin lens and the double curved structures of the symmetrical lens structure. However, both the focal distances of the lenticular lens and the grin lens are nonadjustable. Meanwhile, the 3D display device using the lens can hardly achieve the aim of switching to the 2D image without the aid of other additional devices. Therefore, the existing lens can not meet the use requirement of the field of the glassless 3D displays to a certain extent.

### SUMMARY

The aim of the present invention is to provide a liquid crystal lens with gradience variation of refractive index and a 3D display device which can achieve 3D display of full visual angle.

The liquid crystal lens of the present invention is achieved by the following technical schemes. A liquid crystal lens comprises a lower layer basal plate provided with an electrode and an upper layer basal plate provided with a counter electrode, wherein the lower layer basal plate and the upper layer basal plate are mutually and oppositely arranged, and said electrode and said counter electrode are mutually insulated to form an electric field.

A liquid crystal lens also comprises a liquid crystal layer arranged between said lower layer basal plate and the upper layer basal plate; the liquid crystals are vertical negative nematic LCs.

said electrode of said lower layer basal plate or the counter electrode of said upper layer basal plate is provided with concave curved structures which shorten the distance between the electrode and the counter electrode.

Each said concave curved structure is a curved structure of central symmetry corresponding to its peak. Such design brings the distribution of the tilting liquid crystals in central symmetry using the central peak thereof as the symmetric center.

Each said concave curved structure is of a semi-sphere structure.

Said liquid crystal lens also comprises a voltage regulating device arranged between the electrode and the counter electrode. The voltage between the electrode and the counter electrode can be dynamically regulated by the voltage regulating device to achieve the aim of dynamically regulating the focal distance of the liquid crystal lens.

The electrode of said lower layer basal plate or the counter electrode of said upper layer basal plate is provided with multiple concave curved structures which have the same shape and are arranged in parallel. Multiple focus points can be formed on one liquid crystal lens, so that the liquid crystal lens is similar to the lenticular lens used in the glassless 3D display.

The thickness of said liquid crystal layer is uniform, and an insulating layer is filled between said liquid crystal layer and the concave electrode or the counter electrode.

The purpose of the 3D display device of the present invention is achieved by the following technical schemes. A 3D display device comprises a liquid crystal panel and a liquid crystal lens arranged in front of the liquid crystal panel, wherein said liquid crystal lens comprises:

a lower layer basal plate provided with an electrode and an upper layer basal plate provided with a counter electrode, wherein the lower layer basal plate and the upper layer basal plate are mutually and oppositely arranged, and said electrode and the counter electrode are mutually insulated to form an electric field;

and a liquid crystal layer arranged between said lower layer basal plate and the upper layer basal plate; the liquid crystals are vertical negative nematic LCs;

the electrode of said lower layer basal plate or the counter electrode of said upper layer basal plate is provided with multiple concave curved structures which have the same shape, are arranged in parallel, and shorten the distance between the electrode and the counter electrode.

Each said concave curved structure is a curved structure of central symmetry corresponding to its peak. Such design brings the distribution of the tilting liquid crystals in central symmetry using the central peak thereof as the symmetric center, so that 3D display of full visual angle is achieved.

Each said concave curved structure is of a semi-sphere structure.

Said liquid crystal lens also comprises a voltage regulating device arranged between the electrode and the counter electrode.

Because different tilting angles of the vertical negative nematic LCs of the electric field in gradience variation are used, and the electrode of the lower layer basal plate or the counter electrode of the upper layer basal plate is provided with concave curved structures which shorten the distance between the electrode and the counter electrode; the present invention achieves the aim of the gradience variation of the electric field, and then provide the liquid crystal lens with refractive index in gradience variation, so that the passing light can form focus. If the liquid crystal lens is used in the liquid crystal display (LCD) device, it can replace the existing grin lens or the lenticular lens to achieve the 3D display effect, and the 3D display can be switched to the 2D display conveniently as long as the voltage between the electrode and the counter electrode of the liquid crystal lens is removed.

### BRIEF DESCRIPTION OF FIGURES

FIG. 1 is the schematic diagram of the optical path of the glassless 3D display technique in the prior art;

FIG. 2 is the schematic diagram of the characteristic of the grin lens;

FIG. 3 is the sectional view of an embodiment of the present invention;

FIG. 4 is the schematic diagram of the liquid crystal molecules which are positioned in one structure, i.e. the concave spherical structure in FIG. 3, and which are tilted under the action of the electric field; the viewing angle is downward, i.e. the view is a plane parallel to the XY plane;

FIG. 5 is the schematic diagram of the tilting liquid crystal molecules of the liquid crystal layer in FIG. 3 in different positions under the action of the electric field;

FIG. 6 is the diagram of the refractive index relationship of liquid crystal molecules at different tilting angles in the horizontal electric field;

FIG. 7 is the sectional view of the liquid crystal lens of another embodiment of the present invention.

Wherein:
1. upper layer basal plate;
2. lower layer basal plate;
3. liquid crystal layer;
4. electrode;
5. counter electrode;
6. insulating layer;
8. liquid crystal molecule;
9. concave spherical structure;
10. grin lens;
11. display screen;
12. lenticular lens.

### DETAILED DESCRIPTION

The present invention will further be described in detail in accordance with the figures and the preferred embodiments.

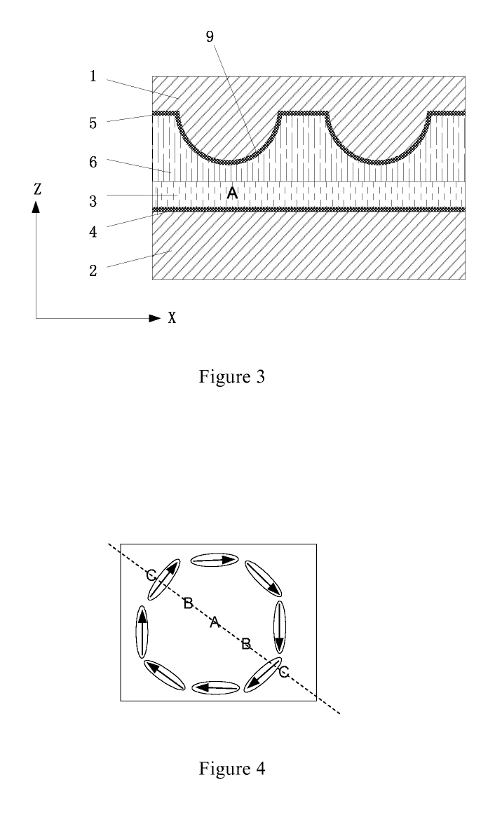

FIG. 3 is the sectional view of the liquid crystal lens of the present invention. As shown in the figure, the liquid crystal lens comprises an upper layer basal plate 1 and a lower layer basal plate 2 which is oppositely arranged to the upper layer basal plate 1, and a liquid crystal layer 3 is arranged between the upper layer basal plate 1 and the lower layer basal plate 2; the inner side of the lower layer basal plate 2 is provided with an electrode 4, and the inner side of the upper layer basal plate 1 is provided with a counter electrode 5 corresponding to the electrode 4; the counter electrode 5 of the upper layer basal plate 1 is insulated from the liquid crystal layer 3 through an insulating layer 6, and the insulating layer can be made of nonconductive polymer material.

In one embodiment of the present invention, the used liquid crystals are vertical negative nematic LCs. When voltage is applied to the electrodes (i.e. electrode 4 and counter electrode 5) of the liquid crystal lens, the liquid crystal molecules are tilted under the action of the electric field so that the refractive index is changed. The liquid crystal molecules of the liquid crystal layer will be tilted at different angles as long as the different positions have different electric field intensity, so that different refractive index distributions can be caused. Therefore, as long as the electrode of the lower layer basal plate or the counter electrode of the upper layer basal plate is provided with concave curved structures which shorten the distance between the electrode and the counter electrode, the gradience variation of the electric field can be achieved, and the gradience variation of refractive index of the liquid crystal lens can be achieved; and the passing light can form focus. When the voltage applied to the counter electrode 5 of the upper layer basal plate 1 or the electrode 4 of the lower layer basal plate 2 is removed, the liquid crystals are vertical at the absence of the action of the electric field; the liquid crystal lens no longer has the gradience variation of refractive index, which is achieved in convenience and swiftness.

The grin lens used in the glassless 3D technique has the characteristic of radial gradience variation of refractive index. The pixel can be divided into multiple subpixels by the grin lens, and subpixels can be projected into the left eye and right eye of a watcher respectively so that the 3D image is formed in the head of the watcher. However, because both the gradience variation of refractive index and the focal distance of the grin lens are constant, and because the shape of the grin lens is solid, the liquid crystal display device can hardly switch between 2D display and 3D display. Therefore, the aforementioned liquid crystal lens can simulate the grin lens in the field of the glassless 3D technique by using the variation of the refractive index of the liquid crystals in the electric field; namely the glassless 3D display effect is achieved by the effect of the gradience variation of refractive index based on the positions of the liquid crystal molecules of the liquid crystals.

The structure of the liquid crystal lens can be described by using the liquid crystal lens used in the liquid crystal display device for glassless 3D display as an example.

### EMBODIMENT 1

The liquid crystal display device for glassless 3D display comprises a liquid crystal panel and a liquid crystal lens arranged in front of the liquid crystal panel. The structure of the first embodiment of said liquid crystal lens is shown in FIG. 3. The counter electrode 5 of the upper layer basal plate 1 of said liquid crystal lens is provided with multiple concave curved structures 9 which have the same shape, are arranged in parallel, and shorten the distance between the electrode and the counter electrode; and the curved structures are of central symmetry corresponding to its peak and are of the semi-sphere structure; correspondingly, the upper layer basal plate 1 is provided with convex regions with the same structure as that of the concave curved structures 9 on the one side corresponding to said counter electrode 5. The thickness of said liquid crystal layer is uniform, and the insulating layer 6 is filled between said liquid crystal layer 3 and the counter electrode 5 so that the counter electrode 5 is insulated from the liquid crystal layer 3. Due to the concave spherical structures 9, the intensity of the electric field formed by the counter electrode 5 and the electrode 4 has gradience variation.

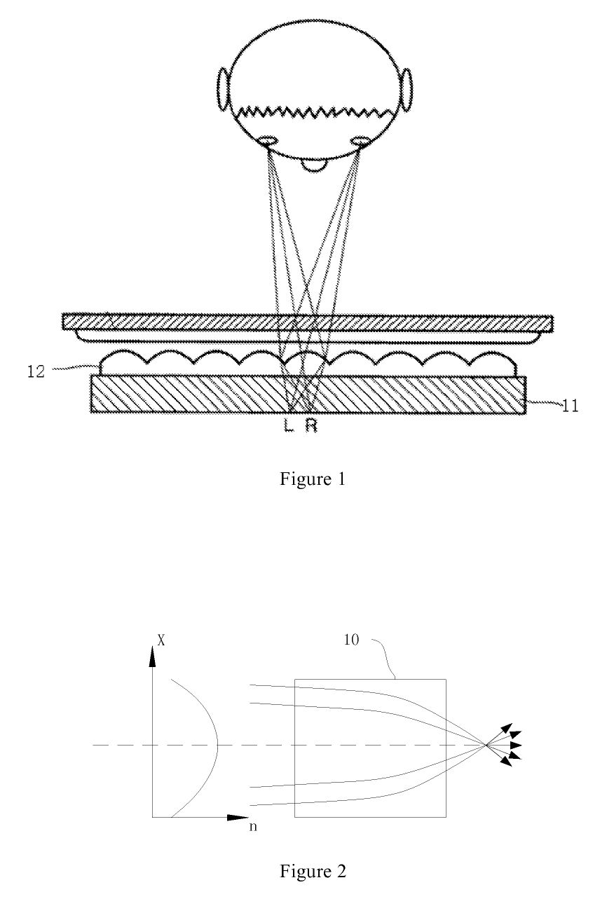

As shown in FIGS. 3 to 5, when incident light enters the liquid crystal lens, as long as the polarization direction of said incident light is vertical to the plane of the lower layer basal plate or has component in the plane, the vertical negative nematic LCs form a clockwise circular formation (FIG. 3 is a two-dimensional view and does not show the Y-axis, and FIG. 4 is the top view of the tilted liquid crystal molecules in the XY plane in one unit structure); in conjunction with FIG. 2 and FIG. 4, the liquid crystal molecules are tilted at different angles under different field intensities; the intensity of the electric field in region A is the maximum because the distance between the electrodes is the minimum, and the liquid crystal molecules in the region A are tilted (from vertical to horizontal directions); because the electric field intensity of the region B is slightly lower than that of the region A, the tilting degree of the liquid crystal molecules in the region B is smaller than that of the liquid crystal molecules in the region A; because the electric field intensity of the region C is lower than that of the region B, the liquid crystal molecules in the region C are hardly tilted. Therefore, within the space of the gradience variation of the electric field intensity, the liquid crystal molecules of the liquid crystal layer 3 from the region A to the region C are tilted in a gradience variation of tilting angles in the electric field of gradience variation, and then the gradience variation of refractive index is formed in the direction from the region A to the region C.

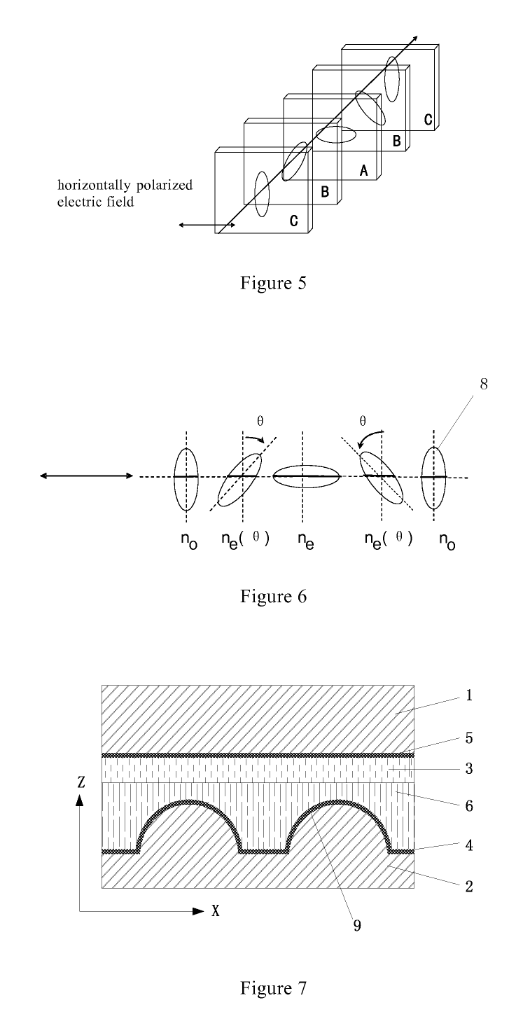

Take the liquid crystal lens shown in FIG. 3 as an example. The liquid crystal molecules are tilted clockwise in a circular formation under the action of the electric field. When the incident direction of the light forms an included angle with the Z-axis, the polarization direction of the incident light is vertical to the XY plane or has a polarized component in the XZ or YZ plane and the light path equivalently forms focus in the XY plane through continuous gradience variation of the refractive index. As shown in FIG. 5 and FIG. 6, the equivalent refractive indexes of the liquid crystal molecules at different tilting angles in the horizontal electric field are nₒ, nₑ(θ), nₑ, nₑ(θ) and nₒ, and their relationship is nₑ>nₑ(θ)>nₒ so that the refractive index in the liquid crystals are in gradience variation. Therefore, as long as the incident polarized light has polarized component vertical to the incident plane, the 3D focusing effect is generated through the gradience variation of the refractive index to achieve the 3D display of full visual angle.

Specially, as shown in FIG. 3, if the counter electrode 5 of the upper layer basal plate 1 is designed with the structure 9 with concave curved structures, the insulating layer 6 is arranged between the counter electrode 5 and the liquid crystal layer so that the counter electrode 5 is insulated from the liquid crystal layer 3; the lower layer basal plate 2 and the electrode 4 thereof are arranged in a plane mode; the vertical negative nematic LCs are used; the liquid crystal molecules are vertical when they are not under the electric field; and the design mode of the electrode 4 of the lower layer basal plate 2 makes the liquid crystal molecules tilted along the clockwise direction to form circular arrangement when the liquid crystals are under the action of the electric field. When the incident direction of light forms an included angle with Z-axis, the polarization direction of said incident light is vertical to the XY plane or has polarized component in the XZ or YZ plane; and the light can produce focusing effect of full visual angle in the XY plane through the liquid crystal layer 3 of which the refractive index is in gradience variation.

### EMBODIMENT 2

The structure of the liquid crystal lens of the embodiment 2 is similar to that of the embodiment 1. As shown in FIG. 5, the difference from the embodiment 1 is that the electrode 4 of the lower layer basal plate 2 is designed with a concave curved structure 9 which shortens the distance between the electrode and the counter electrode; and correspondingly, the side of said lower layer basal plate which corresponds to the side of the electrode 4 is provided with a convex region with the same structure as that of the concave curved structure 9. The thickness of said liquid crystal layer is uniform, and the insulating layer 6 is filled between said liquid crystal layer and the electrode 4 so that the electrode 4 is insulated from the liquid crystal layer 3. The upper layer basal plate 2 and the counter electrode 5 thereof are arranged in plane mode; the vertical negative nematic LCs are used; the liquid crystal molecules are vertical in absence of the electric field; and the design mode of the counter electrode 5 of the upper layer basal plate enables the liquid crystal molecules to be tilted along the clockwise direction to form the circular arrangement when the liquid crystals are under the action of the electric field. When the incident direction of light forms an included angle with Z-axis, the polarization direction of said incident light is vertical to the XY plane or has polarized component in the XZ or YZ plane, and the light can produce focusing effect of full visual angle in the XY plane through the liquid crystal layer 3 of which the refractive index is in gradience variation.

In the present invention, the electrode 4 or the counter electrode 5 of the liquid crystal lens is provided with multiple parallel and gradually concave spherical structures with equal distance between each two lines and between each two rows, like the lenticular lens used in the existing 3D display device. Of course, the concave spherical structures can be divided into multiple rows additionally, and can also be divided into multiple rows and multiple lines if the liquid crystal lens is large enough.

Because the tilting angle of the liquid crystal molecules is related to the intensity of the electric field, different gradience variations of the refractive index can be obtained by applying different voltages to the electrode of the liquid crystal lens, namely the liquid crystal lens can be focalized. Said liquid crystal lens also comprises a voltage regulating device (not shown in the figure) arranged between the electrode and the counter electrode, and the voltage between the electrode and the counter electrode can be dynamically regulated by the voltage regulating device to achieve the aim of dynamically regulating the focal distance of the liquid crystal lens.

The liquid crystal lens can be used in the 3D display device, namely the liquid crystal lens is arranged on the image plane of the current 2D display device. Thus, the lenticular lens or the grin lens used by the existing 3D display device can be replaced, so that the liquid crystal display can display the 3D image. Meanwhile, the 3D display device using the liquid crystal lens can display the 2D image. When 2D image is required to be displayed without displaying the 3D image, the voltage applied to the electrode of the liquid crystal lens can be removed, so that the liquid crystal molecules can not be tilted and the liquid crystal lens can not form the refractive index in gradience variation; namely the liquid crystal lens is the same as the ordinary light transmitting glass. Said liquid crystal lens can also be used in other fields as long as the convex curved structures are adaptably designed. For example, the liquid crystal lens can replace the optical lens in a camera, and can change the focal distance by regulating the voltage.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1, A liquid crystal lens, comprising: a lower layer basal plate provided with an electrode and an upper layer basal plate provided with a counter electrode; the lower layer basal plate and the upper layer basal plate are mutually and oppositely arranged, and said electrode and the counter electrode are mutually insulated to form an electric field; said liquid crystal lens also comprises a liquid crystal layer arranged between said lower layer basal plate and the upper layer basal plate;
the liquid crystals are vertical negative nematic LCs; the electrode of said lower layer basal plate or the counter electrode of said upper layer basal plate is provided with concave curved structures which shorten the distance between the electrode and the counter electrode.

2, The liquid crystal lens of said claim 1, wherein said concave curved structures are curved structures of central symmetry corresponding to its peak.

3, The liquid crystal lens of claim 2, wherein each said concave curved structure is of semi-sphere structure.

4, The liquid crystal lens of claim 1, wherein said liquid crystal lens also comprises a voltage regulating device arranged between the electrode and the counter electrode.

5, The liquid crystal lens of claim 1, wherein the electrode of said lower layer basal plate or the counter electrode of said upper layer basal plate is provided with multiple concave curved structures which have the same shape and are arranged in parallel.

6, The liquid crystal lens of claim 2, wherein the electrode of said lower layer basal plate or the counter electrode of said upper layer basal plate is provided with multiple concave curved structures which have the same shape and are arranged in parallel.

7, The liquid crystal lens of claim 1, wherein the thickness of said liquid crystal layer is uniform, and an insulating layer is filled between said liquid crystal layer and the concave electrode or the counter electrode.

8, A 3D display device comprises a liquid crystal panel and a liquid crystal lens arranged in front of the liquid crystal panel; said lens comprises: a lower layer basal plate provided with an electrode and an upper layer basal plate provided with a counter electrode, wherein the lower layer basal plate and the upper layer basal plate are mutually and oppositely arranged, and said electrode and the counter electrode are mutually insulated to form an electric field; and a liquid crystal layer is arranged between said lower layer basal plate and the upper layer basal plate; the liquid crystals are vertical negative nematic LCs; the electrode of said lower layer basal plate or the counter electrode of said upper layer basal plate is provided with multiple concave curved structures which have the same shape, are arranged in parallel, and shorten the distance between the electrode and the counter electrode.

9, The 3D display device of claim 8, wherein each said concave curved structure is of central symmetry corresponding to its peak.

10, The 3D display device of claim 9, wherein each said concave curved structure is of a semi-sphere structure.

11, The 3D display device of claim 8, wherein said liquid crystal lens also comprises a voltage regulating device arranged between the electrode and the counter electrode.

12, The 3D display device of claim 8, wherein the thickness of said liquid crystal layer is uniform, and an insulating layer is filled between said liquid crystal layer and the concave electrode or the counter electrode.
